(19) United States
(12) Patent Application Publication
(10) Pub. No.: US 2008/0093026 A1
(43) Pub. Date: Apr. 24, 2008

(54) Device for pressing a tape

(76) Inventor: Niko Naumann, Stade (DE)

Correspondence Address: JENKINS, WILSON, TAYLOR & HUNT, P. A., 3100 TOWER BLVD., Suite 1200, DURHAM, NC, 27707, US

(21) Appl. No.: 11/977,444

(22) Filed: Oct. 24, 2007

Related U.S. Application Data
(60) Provisional application No. 60/854,020, filed on Oct. 24, 2006.

(30) Foreign Application Priority Data
Dec. 12, 2006 (DE) 10 2006 058 584.4

(51) Int. Cl. B32B 37/02

(52) U.S. Cl. 156/378; 156/580

(57) ABSTRACT

A device is disclosed for pressing a tape, in particular a thermoplastic, carbon-fiber reinforced tape, for a fiber/tow placement method. A portion of the tape can be pressed by means of a pressure roller on a variable surface contour of a laminating device. An elastomer coating for even pressing of the tape adheres to the circumference of the pressure roller with a material bond. This may provide the advantage that a permanent and reliable connection is created between the elastomer coating and the pressure roller, which furthermore can be easily produced.

### CROSS-REFERENCE TO RELATED APPLICATIONS

This application claims the benefit of U.S. Provisional Application No. 60/854,020, filed Oct. 24, 2006 and German Patent Application No. 10 2006 058 584.4 filed Dec. 12, 2006, the entire disclosures of which are herein incorporated by reference.

### FIELD OF THE INVENTION

The present invention relates to a device for pressing a tape.

Although it can be applied to any devices, the present invention and the problems on which it is based are explained with reference to a device for a fiber/tow placement method for producing aircraft components.

### BACKGROUND OF THE INVENTION

In the aircraft industry, efficient production methods for producing high-strength components from fiber reinforced plastics are becoming increasingly important. The fiber/tow placement method represents such a method. In this method, hot tape, in particular of high-strength thermoplastic materials in strip form with carbon fiber reinforcement, are laid and pressed by means of a pressure roller, whereby an orientation of the carbon fibers that is optimum for the later use of the component can be achieved. In this case, the laminating device has a contoured surface, on which the component to be produced is built up from a number of layers of tape lying one on top of the other.

For high component quality, in particular with respect to strength, it is of decisive importance that the pressure roller produces an even contact pressure over the tape width. On account of the high processing temperatures of the tape of several 100° C., metallic pressure rollers are used. However, these have virtually no elasticity, so that point contact between the pressure roller and the surface of the laminating device occurs in the case of highly contoured laminating devices. The tapes to be laid are consequently not evenly pressed over the full width of the tape and poor consolidation or excessive pressing of the tape layers occurs. Poor laminate quality, in particular with high porosities, and consequently poor component quality, are the consequence.

An approach to this problem that is known to the applicant envisages shrinking an elastic coating onto the circumference of the pressure roller. By means of the elastic coating, an even contact pressure can be achieved. However, with this approach there is the disadvantage that the metallic pressure roller and the elastic coating have different coefficients of thermal expansion, which in the case of such shrunk-on coatings has the effect that they change their position on the pressure roller. This then has the consequence after a short time that the coating is only partially in contact with the tape over the width of the latter, which in turn disadvantageously causes uneven pressing of the tape on the laminating device.

### SUMMARY OF THE INVENTION

It is therefore an object of the present invention to provide a better device, which reliably produces an even contact pressure when pressing the tape on the laminating device.

Accordingly, a device for pressing a tape, in particular a thermoplastic, carbon-fiber reinforced tape, for a fiber/tow placement method is provided. A portion of the tape can in this case be pressed by means of a pressure roller on a variable surface contour of a laminating device. The pressure roller has on its circumference a high-temperature-resistant elastomer coating for even pressing of the tape.

The idea on which the present invention is based is that the elastomer coating adheres to the circumference of the pressure roller with a material bond—by contrast with the frictional bond in the case of the known approach. It can consequently be reliably prevented that the elastic coating changes its position on the circumference of the pressure roller. As a consequence, components can be produced with a consistently high laminate quality.

A further advantage of the invention is that shrinking on of the elastomer coating requires elastomer rings of a quite specific size, which are often not available on the market. Connecting with a material bond, however, can be realized for example by means of molding, without being reliant on prefabricated elastomer rings. Advantageous refinements and improvements of the invention can be found in the subclaims.

A “tape” is to be understood in this patent application preferably as meaning a plastic in strip form, in particular a fiber reinforced plastic in strip form. The plastic in this case may have a thermoplastic content of between 50 and 100%. Carbon fibers or glass fibers come into consideration in particular as fibers. The fibers in the tape may be unidirectionally oriented in the longitudinal direction of the tape.

According to one embodiment of the invention, the pressure roller is overmolded with the elastomer coating. The fact that the elastomer coating is molded on the circumference of the pressure roller, possibly with the addition of adhesion promoters or by means of a suitable surface pretreatment, has the effect of creating better bonding by means of forces of adhesion between the elastomer coating and the pressure roller.

The elastomer coating may be formed at least partially from a perfluororubber and/or a perfluoroelastomer.

According to a further embodiment of the invention, the device has a cooling device for cooling the elastomer coating. Thermoplastic tapes are processed for example at a temperature of about 300° C. At this temperature there is a considerable heat transfer from the tape to the elastomer coating. The elastomer coating, however, is only heat-resistant to a limited extent and rapidly becomes worn at high temperatures. Cooling of it, however, allows continuous processing of very hot tapes and leads to a much longer service life of the elastomer coating.

In the case of a further embodiment of the invention, the cooling device dissipates heat from the elastomer coating on the inside, the pressure roller being of a hollow form for a coolant to flow through it. The inside is intended in the present case to mean the side of the elastomer coating that is facing the circumference of the pressure roller. It is advantageous in the case of this arrangement that a closed cooling circuit can be used, it being possible for the cooling device to be formed very compactly and efficiently, because it is partially integrated in the pressure roller. Water or water mixed with alcohol come into consideration in particular as the coolant.

According to a further embodiment of the invention, by means of the cooling device, a gaseous medium can be directed from the outside onto the elastomer coating. Such an outer cooling device may be provided instead of or in addition to the device for cooling from the inside. It is advantageous in the case of the cooling from the outside that the gaseous cooling medium comes into contact directly with the elastomer coating, and consequently the heat can be dissipated very quickly and effectively from the elastomer coating. Cooled air, nitrogen or other inert gases come into consideration in particular here as the cooling medium.

In the case of a further embodiment of the invention, a control device, which controls the inner and/or outer cooling device in dependence on the temperature of the elastomer coating, is provided. Such a control device makes it possible for the temperature of the elastomer coating to be accurately controlled by an open-loop and/or closed-loop system. The elastomer coating can consequently be prevented from becoming too hot, and therefore degrading, but also from cooling down too much, and the hot tape consequently cooling down unnecessarily on its surface, which in turn could adversely affect the quality of the laminate. An electronic, stored-program controller comes into consideration as the control device. This can be adapted very easily to the respective control requirements.

According to a further embodiment of the invention, a measuring device, which contactlessly records the temperature of the elastomer coating and presents it to the control device, is provided. The measuring device may be a pyrometer. Contactless recording is advantageous to the extent that the elastomer coating becomes soiled with remains of plastic during operation and, in addition, also moves, which would severely hinder measurement based on contact.

The control device may also advantageously comprise a first controller, for the inner cooling of the elastomer coating, in particular a thermostat or a cryostat, and a second controller, for the outer cooling of the elastomer coating, for example a flow monitor and valves for limiting the gas through-flow. The input of a reference variable, that is to say for example the setting of a desired temperature of the elastomer coating, in the stored-program controller leads to the output in each case of a manipulated variable, in dependence on the measured temperature of the elastomer coating at the first and second controllers.

According to a further embodiment of the invention, the elastomer coating is pivotably mounted with respect to the axis of rotation of the pressure roller, in particular by means of a universal ball joint. This makes it possible to compensate for skewed axial inclinations of the pressure roller with respect to the surface in the pressing region, i.e. even planes that are aligned parallel to a vector of the rolling direction of the pressure roller and form a point of intersection with the axis of rotation of the pressure roller can be evenly subjected to pressure. It is possible to provide additional actuators and controllers, which control the inclination of the elastomer coating with respect to the axis of rotation in a closed-loop and/or open-loop manner. This produces greater flexibility with respect to the surface contour of laminating devices, which has the consequence that components with more complex forms can be produced by means of the device.

In the case of a further embodiment of the present invention, the pressure roller has a number of roller portions mounted movably in relation to one another. This makes it possible for very wide tapes to be pressed on laminating devices with a greatly varying gradient transversely to the rolling direction. The processing of wide tapes leads to an even more homogeneous build-up of the laminate as opposed to the use of a number of narrow tapes, and can lead to a more stable component.

### BRIEF DESCRIPTION OF THE DRAWINGS

The invention is explained in more detail below on the basis of exemplary embodiments with reference to the accompanying figures of the drawing, in which:

FIG. 1 shows a device according to a first exemplary embodiment of the present invention in a side view;

FIG. 2 shows a section along the sectional line A-A from FIG. 1;

FIG. 3 shows the tape device from FIG. 1 with the assigned cooling device and control device as a block diagram in a perspective and highly schematized form; and

FIG. 4 shows a device according to a further exemplary embodiment of the invention.

Unless otherwise specified, in the figures the same reference numerals designate components that are the same or functionally the same.

### DETAILED DESCRIPTION OF THE INVENTION

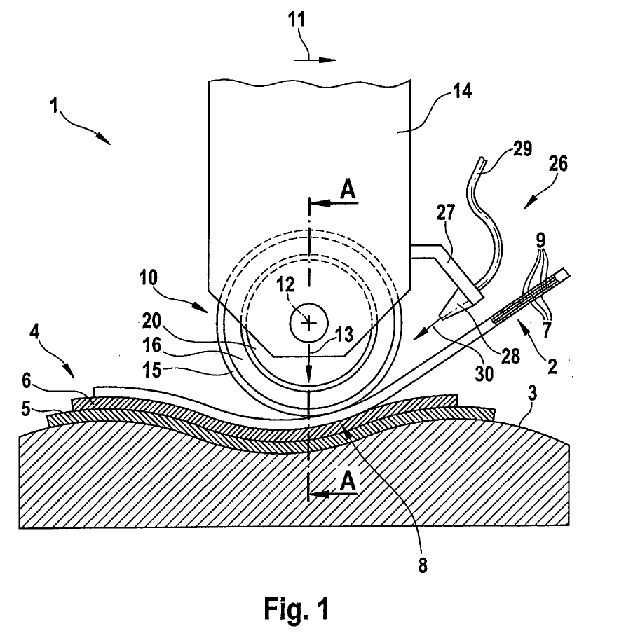

FIG. 1 shows in a side view a device 1 for the directed laying and pressing of tape 2 in strip form on a surface contour 3 of a laminating device 4. Laminate layers 5 and 6 have already built up on the surface contour 3.

The tape 2 has a structure of unidirectional carbon fibers 7 in the longitudinal direction of the tape, which are embedded in a thermoplastic matrix 9.

The tape 2 is first heated (not represented), the thermoplastic matrix 9 becoming at least partially melted. Subsequently, the hot tape 2 is fed to a pressure roller 10 of the device 1, which presses a portion 8 of the tape 2 onto the laminate layer 6, which in turn is supported by the laminate layer 5 and the surface contour 3. In this case, the pressure roller is moved in the direction of the arrow 11, it rotating about its axis of rotation 12 and being subjected to a force 13 in the direction of the arrow.

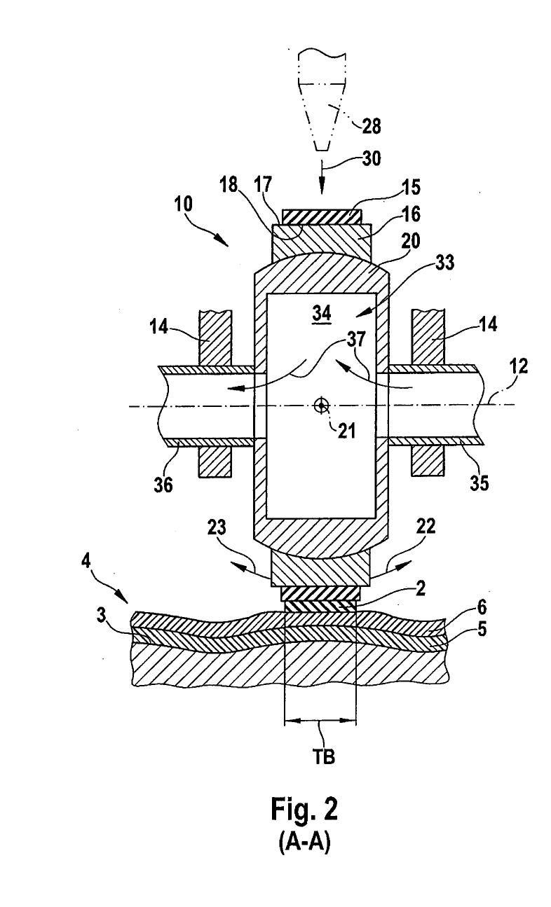

FIG. 2 shows a sectional view along the sectional line A-A from FIG. 1. The pressure roller 10 is rotatably mounted about its axis of rotation 12 in the mounting 14. A bearing shell 16, preferably of steel, of the pressure roller 10 is overmolded on its outer circumference 17 with an elastomer coating 15, preferably by the injection-molding process. Adhesion promoters are possibly added during the production of the elastomer coating 15, or a suitable surface preparation of the outer circumference 17 is possibly performed during or before the overmolding. The elastomer coating 15 thereby firmly bonds by means of forces of adhesion to the outer circumference 17 of the bearing shell 16. On the inside, the bearing shell 16 is pivotably mounted on a universal ball joint 20. The pivoting is in this case performed about an axis 21 perpendicular to the axis of rotation 12.

If the pressure roller 10 is then made to move along a varying surface contour 3, even pressing of the tape 2 over its width TB is ensured by means of two complementing operating mechanisms:

The first operating mechanism is provided by the inherent elasticity of the elastomer coating. This elasticity makes the elastomer coating 15 lie evenly against the surface contour 3 when there are variations of the surface contour 3 both longitudinally and transversely to the rolling direction 11 that extend in particular only over part of the tape width TB.

The second operating mechanism is provided by t he pivoting movement, indicated by the arrows 22 and 23, of the bearing shell 16 about the pivot axis 21. By means of this operating mechanism it is possible to compensate for variations in the surface contour 3 transversely to the rolling direction 11 that extent over the entire tape width TB. Therefore, even planes that are aligned parallel to the vector of the rolling direction, in the present case the direction of movement 11, of the pressure roller 10 and form a point of intersection with the axis of rotation 12 of the pressure roller 10 can be evenly subjected to pressure.

As already stated at the beginning, cooling of the elastomer coating 15 is required on account of the high heat transfer from the hot tape 2 to the elastomer coating 15 and the limited heat resistance of the latter.

FIGS. 1 and 2 also show an outer cooling device 26, which is fastened to the mounting 14 by means of an arm 27. The outer cooling device 26 is merely schematically represented and comprises for example a nozzle 28, which is supplied with a cold gas stream by means of a hose 29. The nozzle 28 blasts the concentrated gas stream 30 onto the elastomer coating 15, whereby the latter is cooled. The gas stream 30 may, for example, comprise cooled air.

According to FIG. 2, in addition to the outer cooling device 26 or instead of it, the elastomer coating 15 is cooled on its inner surface 18, facing the circumference 17 of the bearing shell 16, by means of an inner cooling device 33.

The inner cooling device 33 provides that the universal ball joint 20 is of a hollow form. The hollow space 34 that is formed is also provided with connections 35 and 36, which allow the supply and discharge of a coolant 37, for example water, into and from the hollow space 34.

By means of the inner cooling device 33, heat can consequently be dissipated easily and effectively from the inner side of the elastomer coating 15, facing the circumference 17. As a result, the bearing shell 16 and the universal ball joint 20 are preferably formed from a material that has good heat conduction, for example steel.

For the sake of simplicity, the complete cooling circuit is not represented in FIG. 2; only portions of the connections 35 and 36 are respectively depicted. It goes without saying that any kind of cooling circuit, for example by means of a compressible coolant, is conceivable. The pressure roller 10 is preferably rotatably mounted in the mounting 14 in the region of the connections 35, 36.

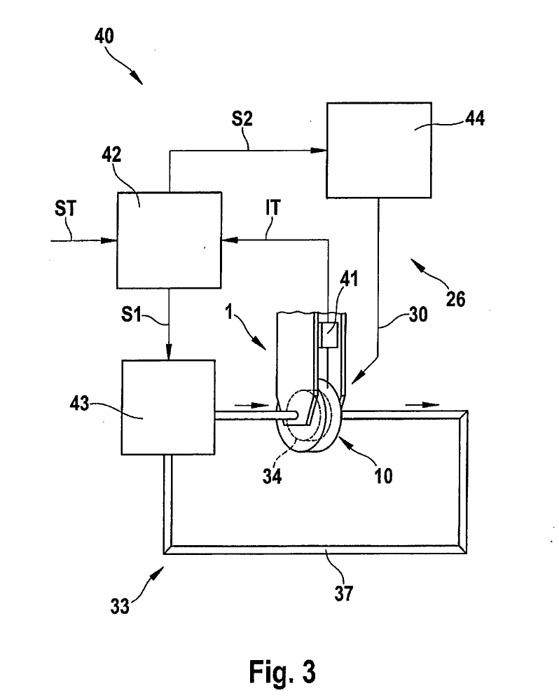

FIG. 3 schematically and perspectively shows the device from FIGS. 1 and 2 and also a control circuit 40 assigned to it for controlling the temperature of the elastomer coating 15.

By contrast with FIGS. 1 and 2, the device 1 has a measuring device, formed for example as a pyrometer 41, for the contactless recording of the actual temperature IT of the elastomer coating. The actual temperature IT measured by the pyrometer 41 is presented to a control device formed as a stored-program controller (SPC) 42. The SPC 42 compares the actual temperature with a setpoint temperature ST, which can be input for example by the user via a display or else is calculated by the SPC in dependence on a measured temperature of the fed-in tape 2. Typically, the setpoint temperature ST should be chosen such that a long service life of the elastomer coating 15 is achieved. Accordingly, the setpoint temperature ST should not in any case exceed the maximum heat resistance of the elastomer coating 15.

In dependence on the result of the comparison between the actual temperature IT and the setpoint temperature ST, a first control signal Si is output to a cryostat or thermostat or combined cryothermostat 43. In dependence on the control signal Si, the cryostat or thermostat or cryothermostat 43 correspondingly sets the temperature of the cooling medium that flows through the hollow space 34 of the pressure roller 10. For example, the flow rate of the cooling fluid 37 may be increased or reduced or its temperature changed by means of heating or cooling.

A second measuring signal S2 is output to an open-loop or closed-loop controller 44, which, in dependence on the control signal S2, controls the gas stream 30 that is directed at the elastomer coating 15.

Consequently, optimum cooling of the elastomer coating 15 can be achieved by means of the outer and/or inner cooling device 26 and 33, respectively.

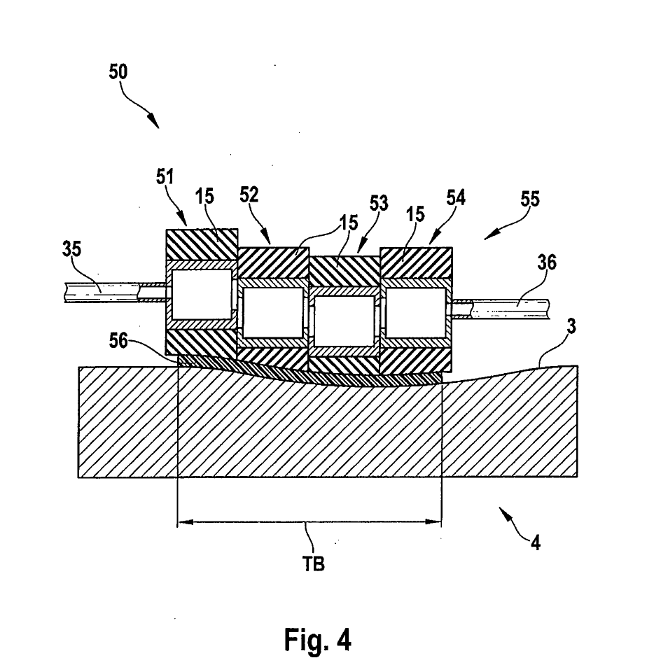

FIG. 4 schematically shows a further device 50, which differs from the device 1 according to FIGS. 1 to 3 in that a pressure roller 55 is formed by a number of roller portions 51, 52, 53, 54 mounted in relation to one another. A much wider tape 56 can be pressed on the surface contour 3 of the laminating device 4, with great variation of the surface contour 3 with respect to the tape width TB, by means of the pressure roller 55 formed in this way in comparison with the pressure roller 10 from FIG. 1.

Although the present invention has been described in the present case on the basis of preferred exemplary embodiments, it is not restricted to these but can be modified in various ways.

For example, instead of or in addition to the thermoplastic matrix, the tape could comprise a thermosetting matrix or some other matrix.

The arrangement and form of the inner and outer cooling devices may be modified in any way desired. For example, a multiplicity of nozzles could be provided for blasting onto the elastomer coating.

The bearing shell, the supply, discharge and/or the universal ball joint may be formed from any material that is suitable for the high temperatures and forces, for example metal or plastic.

An application of the device is in no way restricted to fiber/tow placement methods. Rather, the device is suitable for any desired methods for pressing tape, for example for a tape laying method.

The present invention provides a device for pressing a tape, in particular a thermoplastic, carbon-fiber reinforced tape, for a fiber/tow placement method. The tape can be pressed by means of a pressure roller on a variable surface contour of a laminating device. The special feature here is that an elastomer coating adheres to the circumference of the pressure roller with a material bond. In addition, there is the advantage that a permanent and reliable connection is created between the elastomer coating and the pressure roller, which furthermore can be easily produced.

What is claimed is:

1. A device for pressing a tape in a laminating device, the device comprising at least one pressure roller for pressing at least one portion of the tape onto a surface contour of the laminating device, the pressure roller having on its circumference a high-temperature-resistant elastomer coating for even pressing of the at least one portion of the tape onto the surface contour, wherein the elastomer coating adheres to the circumference of the pressure roller with a material bond.

2. The device according to claim 1, wherein the pressure roller is overmolded with the elastomer coating.

3. The device according to claim 1, wherein a cooling device for cooling the elastomer coating is provided.

4. The device according to claim 3, wherein the cooling device dissipates heat from the elastomer coating on the inside, the pressure roller being of a hollow form for a coolant to flow through it.

5. The device according to claim 3, wherein a gaseous cooling medium can be directed by the cooling device from the outside onto the elastomer coating.

6. The device according to claim 3, further comprising a control device, which controls the cooling device in dependence on the temperature of the elastomer coating.

7. The device according to claim 6, further comprising a measuring device, which contactlessly records the temperature of the elastomer coating and presents the temperature to the control device.

8. The device according to claim 1, wherein the elastomer coating is pivotably mounted with respect to the axis of rotation of the pressure roller.

9. The device according to claim 8, wherein the elastomer coating is pivotably mounted with respect to the axis of rotation of the pressure roller by a universal ball joint.

10. The device according to claim 1, wherein the pressure roller has a number of roller portions mounted movably in relation to one another.

11. The device according to claim 1, wherein the tape is a thermoplastic, carbon-fiber reinforced tape.
